(19) United States
(12) Patent Application Publication
(10) Pub. No.: US 2020/0125353 A1
(43) Pub. Date: Apr. 23, 2020

(54) PRODUCT FEATURE NOTIFICATION AND INSTRUCTION IN A CONTINUOUS DELIVERY SOFTWARE DEVELOPMENT ENVIRONMENT

(71) Applicant: International Business Machines Corporation, Armonk, NY (US)

(72) Inventors: Shaprieh Bean, Santa Clara, CA (US); Dario D'Angelo, Los Gatos, CA (US)

(21) Appl. No.: 16/167,849

(22) Filed: Oct. 23, 2018

(51) Int. Cl. G06F 8/65; G06F 8/73; G06F 17/30; H04L 29/08

(52) U.S. Cl. CPC G06F 8/65; H04L 67/34; G06F 17/30368; G06F 8/73

(57) ABSTRACT

Embodiments include methods, systems, and computer program products for determining and providing a feature notification within a mainframe environment. The computer-implemented method includes generating, using a processor within the mainframe environment, one or more new features or feature updates. The processor further assembles documentation associated with the one or more new features or feature updates. The processor further transmits the assembled documentation to one or more user devices. The processor further transmits the one or more new features or feature updates to the one or more user devices in response to receiving a request to download the one or more new features or features updates to the one or more user devices.

### BACKGROUND

The present invention relates in general to software development and more specifically, to tracking new feature releases or updates, notifying users/customers of the new feature releases or updates and providing customers with documentation and instructions necessary to fully take advantage of the new feature releases or updates.

In the field of software development, improvements to software are constantly being sought. Features are constantly being added to software or existing features are updated.

Accordingly, part of the software product development process may be to improve current software product functionality and to introduce and/or activate new product functionality through the continuous release of new versions of the software. When introducing new releases of the software product, customers may not be aware of these improvements.

### SUMMARY

Embodiments of the invention are directed to a method for determining and providing a feature notification within a mainframe environment. A non-limiting example of the computer-implemented method includes generating, using a processor within the mainframe environment, one or more new features or feature updates. The processor further assembles documentation associated with the one or more new features or feature updates. The processor further transmits the assembled documentation to one or more user devices. The processor further transmits the one or more new features or feature updates to the one or more user devices in response to receiving a request to download the one or more new features or features updates to the one or more user devices.

Embodiments of the invention are directed to a computer program product that can include a storage medium readable by a processing circuit that can store instructions for execution by the processing circuit for performing a method for determining and providing a feature notification within a mainframe environment. The method includes generating one or more new features or feature updates. The processor further assembles documentation associated with the one or more new features or feature updates. The processor further transmits the assembled documentation to one or more user devices. The processor further transmits the one or more new features or feature updates to the one or more user devices in response to receiving a request to download the one or more new features or features updates to the one or more user devices.

Embodiments of the invention are directed to a system. The system can include a processor in communication with one or more types of memory. The processor can be configured to generate one or more new features or feature updates. The processor can be configured to assemble documentation associated with the one or more new features or feature updates. The processor can be configured to transmit the assembled documentation to one or more user devices. The processor can be configured to transmit the one or more new features, functionality, or feature updates to the one or more user devices in response to receiving a request to download the one or more new features or features updates to the one or more user devices.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The foregoing and other features, and advantages of the disclosure are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 is a block diagram illustrating one example of a processing system for practice of the teachings herein;

FIG. 4 is a block diagram illustrating a computing system according to one or more embodiments of the present invention; and

FIG. 5 is a flow diagram of a method for determining and providing a feature notification within a mainframe environment according to one or more embodiments of the present invention.

The diagrams depicted herein are illustrative. There can be many variations to the diagram or the operations described therein without departing from the spirit of the invention. For instance, the actions can be performed in a differing order or actions can be added, deleted, or modified. In addition, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments of the invention, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e., one, two, three, four, etc. The terms “a plurality” may be understood to include any integer number greater than or equal to two, i.e., two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, embodiments of the invention are related in general to software development. Agile software development is an approach to software development under which requirements and solutions evolve through the collaborative effort of self-organizing and cross-functional teams and their customer(s)/end user(s). It advocates adaptive planning, evolutionary development, early delivery, and continual improvement, and it encourages rapid and flexible response to change. The main idea behind agile software development may be to divide the development process into short iterations and be able to demonstrate intermediate results to end users right after each of the software development iteration steps. Having received the feedback of the users, the development process for a software component may continue, be modified or, may be dropped completely.

Agile software development can occur on a variety of computer platforms/architectures, for example, mainframe systems. Mainframe systems like system z products (i.e., products based on a system utilizing a z/OS operating system developed and marketed by International Business Machines Corporation (IBM)) significantly diverge from most x86 based products (i.e., products designed for use with a CPU instruction set compatible with the Intel 8086 and its successors.) New features and/or functions cannot be casually or automatically toggled on (activated) on mainframe systems since a risk of instability to the system is problematic leading to customer dissatisfaction. Accordingly, system z products resort to commands or conceptually similar means to make the feature available, while allowing a product owner to have some control of a feature activation timing in order to control and mitigate possible instabilities to the system.

While an agile software development (i.e., continuous delivery (CD)) approach is becoming more predominant within the system z product design, agile software development in a z/OS ecosystem presents a new set of challenges. A significant challenge to using agile software development in a z/OS ecosystem is a lack of an ability to notify the customers of a given feature availability (e.g., a new feature or a feature update), how to activate the feature and how the feature can and/or should be used. The use and adoption of a given feature introduced through CD process relies mostly on the customer/user becoming aware of the feature, activating the feature through a manual toggle action and incorporating new functionalities associated with the feature into new or existing customer products without destabilizing the system.

Turning now to an overview of the aspects of the invention, one or more embodiments of the invention address the above-described shortcomings of the prior art by enabling a new feature of a mainframe product, created and delivered using an agile/continuous delivery software approach, informing customers about functionality of the mainframe product, use and implementation of the feature in a manner that prevents destabilizing a customer's system environment. In addition, the customer can be provided with information related to how to activate said feature, the implications of using the feature, in order for the customer to make an informed decision on whether the feature should or should not be enabled.

The above-described aspects of the invention address the shortcomings of the prior art by actively monitoring feature releases, providing notifications to customers regarding the released features, providing information and know-how on functionality related to the feature, highlight the potential impact on the environment, differences with older associated features or versions of the feature, use of the features and possible implementations of the feature within a z/OS ecosystem. Accordingly, time can be saved when deploying and/or implementing new functionality within a production environment by the user, as well as improving feature adoption by customers.

It is understood in advance that although this disclosure includes a detailed description on cloud computing, implementation of the teachings recited herein are not limited to a cloud-computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud-computing environment is service oriented with a focus on statelessness, low coupling, modularity, and semantic interoperability. At the heart of cloud computing is an infrastructure comprising a network of interconnected nodes.

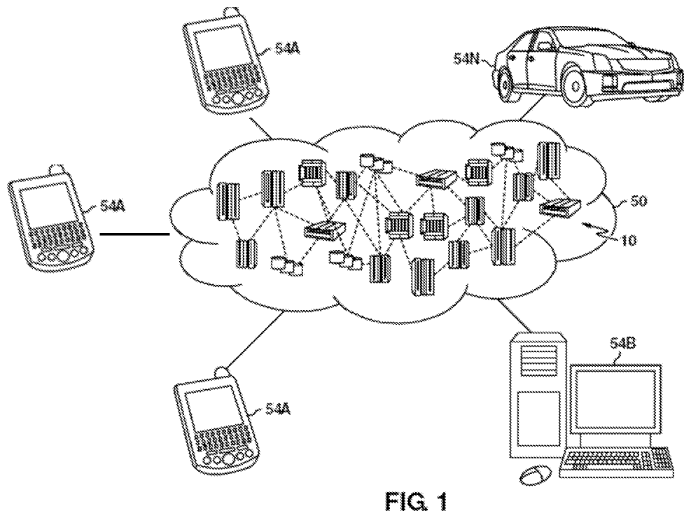

Referring now to FIG. 1, illustrative cloud computing environment 50 is depicted. As shown, cloud-computing environment 50 comprises one or more cloud computing nodes 10 with which local computing devices used by cloud consumers, such as, for example, personal digital assistants (PDA) or cellular telephones 54A (mobile devices), desktop computer 54B, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud-computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

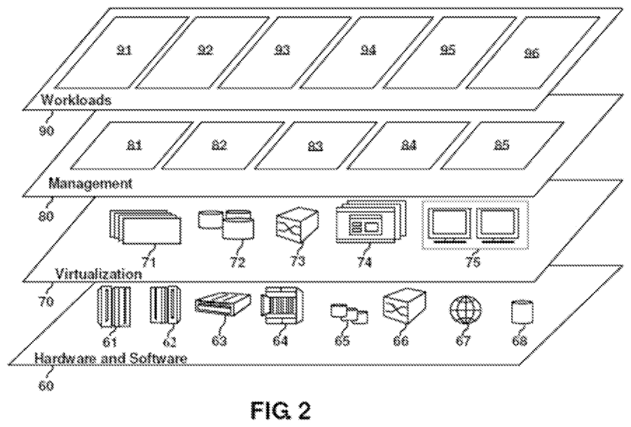

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud-computing environment. Metering and Pricing 82 provide cost tracking as resources are utilized within the cloud-computing environment, and billing or invoicing for consumption of these resources. In one example, these resources may comprise application software licenses. Security provides identity verification for cloud consumers and tasks, as well as protection for data and other resources. User portal 83 provides access to the cloud-computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions that may be provided from this layer include: mapping and navigation 91; software development and lifecycle management 92; virtual classroom education delivery 93; data analytics processing 94; transaction processing 95; and software feature change management 96. Embodiments described herein can be performed in a non-cloud-computing environment.

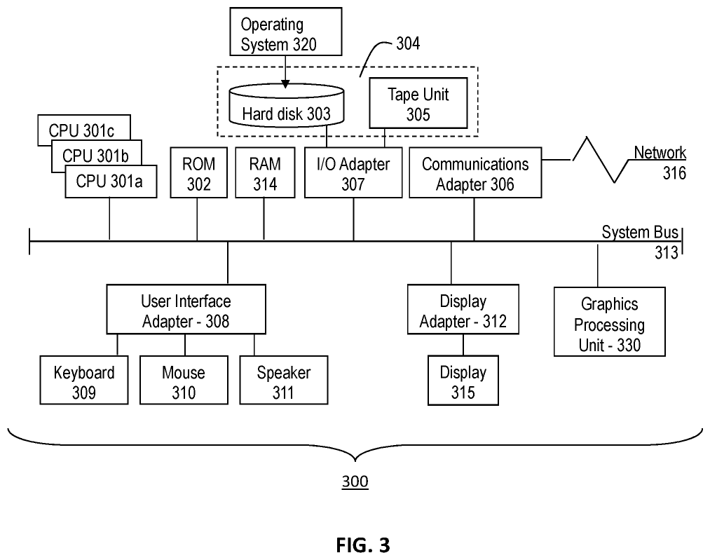

Referring to FIG. 3, there is shown a processing system 300 for implementing the teachings of the present disclosure according to one or more embodiments of the invention described herein. The system 300 has one or more central processing units (processors) 301a, 301b, 301c, etc. (collectively or generically referred to as processor(s) 301). In one embodiment, each processor 301 may include a reduced instruction set computer (RISC) microprocessor. Processors 301 are coupled to system memory 314 and various other components via a system bus 313. Read only memory (ROM) 302 is coupled to the system bus 313 and may include a basic input/output system (BIOS), which controls certain basic functions of system 300.

FIG. 3 further depicts an input/output (I/O) adapter 307 and a communications adapter 306 coupled to the system bus 313. I/O adapter 307 may be a small computer system interface (SCSI) adapter that communicates with a hard disk 303 and/or tape storage drive 305 or any other similar component. I/O adapter 307, hard disk 303, and tape storage device 305 are collectively referred to herein as mass storage 304. Operating system 320 for execution on the processing system 300 may be stored in mass storage 304. A communications adapter 306 interconnects bus 313 with an outside network 316 enabling data processing system 300 to communicate with other such systems. A screen (e.g., a display monitor) 315 is connected to system bus 313 by display adapter 312, which may include a graphics adapter to improve the performance of graphics intensive applications and a video controller. In one embodiment, adapters 307, 306, and 312 may be connected to one or more I/O busses that are connected to system bus 313 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 313 via user interface adapter 308 and display adapter 312. A keyboard 309, mouse 310, and speaker 311 all interconnected to bus 313 via user interface adapter 308, which may include, for example, a Super I/O chip integrating multiple device adapters into a single integrated circuit.

In exemplary embodiments of the invention, the processing system 300 includes a graphics-processing unit 330. Graphics processing unit 330 is a specialized electronic circuit designed to manipulate and alter memory to accelerate the creation of images in a frame buffer intended for output to a display. In general, graphics-processing unit 330 is very efficient at manipulating computer graphics and image processing and has a highly parallel structure that makes it more effective than general-purpose CPUs for algorithms where processing of large blocks of data is done in parallel.

Thus, as configured in FIG. 3, the processing system 300 includes processing capability in the form of processors 301, storage capability including system memory 314 and mass storage 304, input means such as keyboard 309 and mouse 310, and output capability including speaker 311 and display 315. In one embodiment, a portion of system memory 314 and mass storage 304 collectively store an operating system such as the AIX® operating system from IBM Corporation to coordinate the functions of the various components shown in FIG. 3.

In complex computing environments, (e.g., mainframe computers and operating systems and software operating on mainframe computers), notifying customers of new features or updates, as well as incorporating the new features or feature updates into a user's system presents more challenges than personal computers and electronics because changes to the complex computing environments can more easily cause instability to the complex computing environments that personal computers, which are typically less specialized and compute intensive. An automatic update typical of personal computers will not suffice when updating complex computing environments because a programmer/developer has to fully understand the ramifications of introducing a new feature or feature update to a system. A new feature in such an environment can have a high degree of complexity (e.g., not just a simple button new shape as in a personal computer/consumer application). Accordingly, notifications are provided to the programmer/developer about new features and feature updates during a major release (e.g., once a year). However, with agile software development, software releases occur more rapidly (e.g., every two weeks or month) and the customer and/or programmer/developer may fail to appreciate software changes that may have occurred preventing the programmer/developer from fully leveraging any new functionality. Accordingly, adoption of new features and/or feature updates can suffer due to a lack of knowledge that the new features and/or feature updates exist, as well as a lack of understanding of how to install the new or updated feature and/or use the new or updated feature.

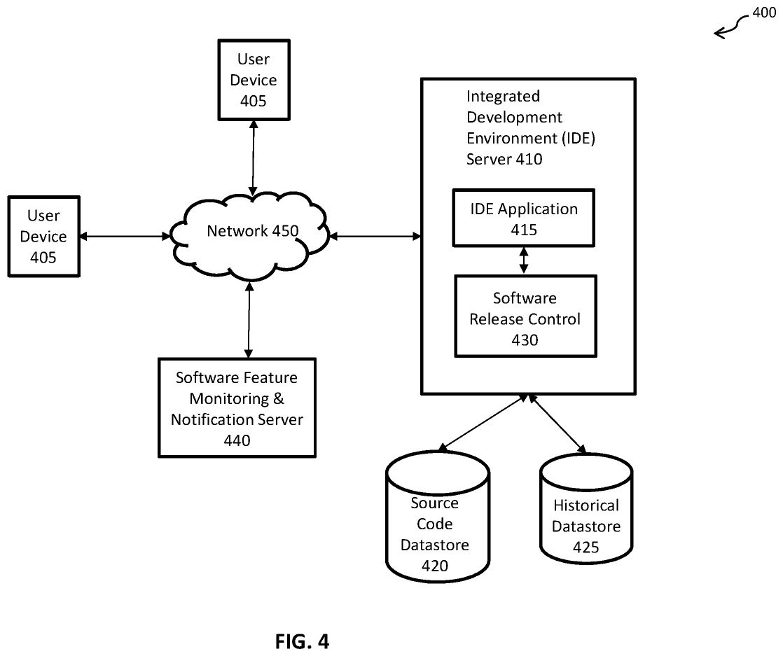

Referring now to FIG. 4, there is illustrated a computing system 400 in accordance with one or more embodiments of the invention. As illustrated, the computing system 400 can include but is not limited to, one or more user devices 405, an integrated development environment (IDE) server 410, and a software feature monitoring and notification server 440 connected over one or more networks, for example, network 450.

The one or more user devices 405 can be any type of computing device, such as a computer, laptop, tablet, etc. The IDE server 410 can be any type of computing device, such as a computer, laptop, tablet, etc. The IDE server 410 can include IDE application 415 and software release control 430. The IDE application 415 further includes, or has access to, a source code datastore 420, and a historical test data datastore 425.

The IDE application 415 can provide at least a code editor, compiler, and debugger to allow software developers, for example, via the one or more user devices 405, to write software code, compile the code into modules, and test and debug the modules and execute test cases. The source code datastore 420 can represent a datastore in which source code for one or more software products under development are stored. In certain embodiments, source code datastore 420 can be included in, and maintained by, a software version control system (not shown) that manages changes to the source code. The source code datastore 420 can also store additional information related to source code modules, such as changed lines, which project task (feature or “line item”) each source code module change is associated with, and compile and debug errors by module. This information may be provided and maintained, for example, by the IDE application 415 or by a software version control system that manages changes to the source code modules.

The historical test data datastore 425 can represent a datastore in which information related to test cases is stored. Generally, a test case is a set of conditions under which one or more features of a software product are executed, along with the expected results, to determine whether the features are performing as expected. The conditions may include, for example, test data, pre-conditions, and post-conditions, developed for a particular test scenario. The historical test data datastore 425 can include test cases created by a product test organization to determine whether the features of the software product are performing as expected, the code coverage and modules or subroutines exercised by each test case, the number of test cases created for the software product, test case size, test case execution duration, etc. The historical test data datastore 425 can also include historical data, such as test case failures, or defects discovered, by feature or module for previous versions of the software product, as well as up-to-date test case failures by feature or module for the version of the software product currently under development. The software release control 430 can include a product release history and documentation associated with the release product.

The software feature monitoring and notification server 440 can monitor each stage associated with a continuous delivery (CD) model. For example, CD stages can include: an assignment stage in which a delivery team can be directed develop or update a product feature, a version control stage, a build and unit test stage, an automated acceptance test stage, a user acceptance stage, a release stage, and a feature release notification stage. Accordingly, software feature monitoring and notification server 440 can keep track of when a product is to be released to customers. Accordingly, when the product is ready to be released, the software feature monitoring and notification server 440 can obtain customer information associated with the product. The software feature monitoring and notification server 440 can, upon an indication that the product is ready to be released, notify each customer associated with the release product about changes to the product (updates or replacement products).

An exemplary notification can be the following:

Subject: IMS Version 50.0.2, now offers Java enablement

Sent by: IMS ASN V2 on the z/OS image STLABE0

<IMSV50@domain.com>

You can now write Java applications to access IMS databases and process IMS transactions by using the drivers and resource adapters of the IMS solutions for Java development.

The Java enablement includes the IMS Universal drivers, the IMS Java dependent region resource adapter, the classic Java APIs for IMS, and the IMS Transaction Manager Resource Adapter (IMS TM Resource Adapter).

These solution can be activated by the following command: SET JAVA ON.

For solutions that can also run on distributed platforms, you can download them from the IMS download site at www.ims.com

For developing Java applications that run in IMS, see the Java in IMS solution adoption kit for end-to-end guidance, including tasks for system programmers to set up the environment.

The software feature monitoring and notification server 440 can also provide each customer with documentation related to a new or updated feature associated with the product. The documentation can include a description of the new or updated feature, pointers to solution kits associated with the new or updated feature, video or other documentation on how to use the new or updated feature, installation information and/or files/scripts to install the new or updated feature, and who to contact for more information about the new or updated feature, etc.

The software feature monitoring and notification server 440 can generate a notification framework to provide notifications to each user device 405 based on preferences received from each user device 405 indicating when and how notifications should be sent to each user device 405 from the software feature monitoring and notification server 440. The preferences can be related to a preferred notification type (e.g., e-mail, telephone, text, etc.). The software feature monitoring and notification server 440 can also communicate with each user device 405 in order to determine or receive information related to a current system state of the user device 405 which can be used determine if additional features or updates previously released that have not been incorporated by a user device 405 should be included in the notification because the current feature or update builds or relies on at least a portion of the additional features or updates previously released. For example, the programmer/developer may not have added one or more new features or feature updates to an associated user device 405. When the software feature monitoring and notification server 440 notifies the programmer/developer of a new feature or feature update, the software feature monitoring and notification server 440 can also include previously released features or feature updates that have not been added the user device 405 but are needed for the incorporation of the new feature or feature update on user device 405, as well as any documentation related to the previously released new features or feature updates.

The network(s) 450 can include, but are not limited to, any one or a combination of different types of suitable communications networks such as, for example, cable networks, public networks (e.g., the Internet), private networks, wireless networks, cellular networks, or any other suitable private and/or public networks. Further, the network(s) 450 can have any suitable communication range associated therewith and can include, for example, global networks (e.g., the Internet), metropolitan area networks (MANs), wide area networks (WANs), local area networks (LANs), or personal area networks (PANs). In addition, the network(s) 450 can include any type of medium over which network traffic can be carried including, but not limited to, coaxial cable, twisted-pair wire, optical fiber, a hybrid fiber coaxial (HFC) medium, microwave terrestrial transceivers, Bluetooth, and/or a wireless network radio (such as a radio capable of communication with a wireless communication network such as a Long Term Evolution (LTE) network, WiMAX network, 3G network, etc.), satellite communication mediums, or any combination thereof.

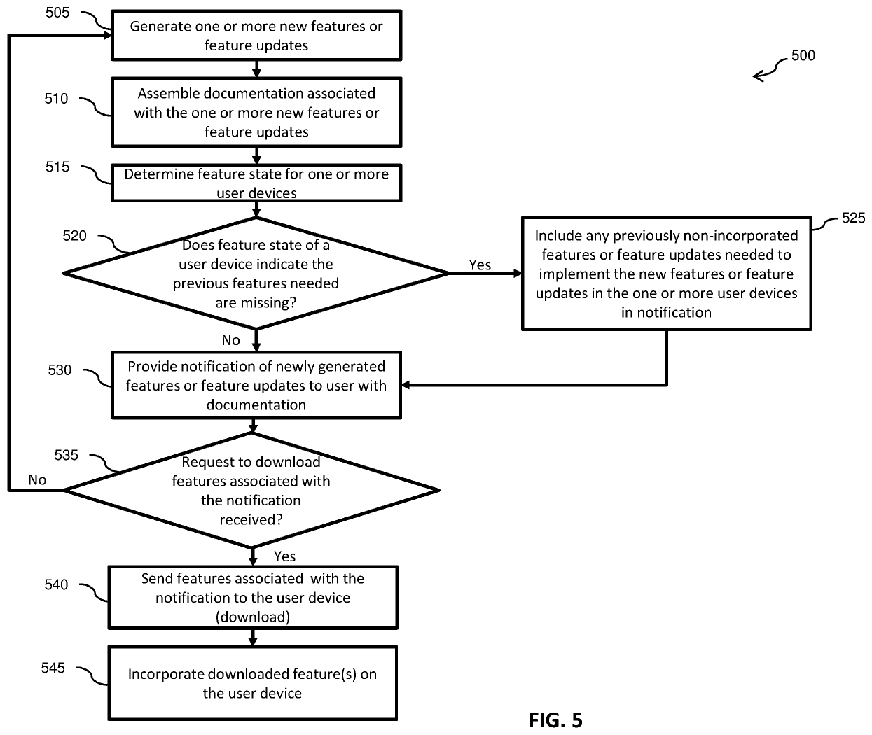

Now referring to FIG. 5, a flow diagram of a method 500 for determining and providing a feature notification within a mainframe environment in accordance with one or more embodiments of the present invention. At block 505, one or more new features or feature updates can be generated on a user device, for example, user device 405. The new features or feature updates can be related to new or improved functionality within a computing system/environment, for example, a mainframe system. At block 510, the computer-implemented method can assemble documentation (i.e., pointers to solution kits associated with the new or updated feature, video or other documentation on how to use the new or updated feature, installation information and/or files/scripts to install the new or updated feature, and who to contact for more information about the new or updated feature, etc.) related to the one or more new features or feature updates.

At block 515, the computer-implemented method can communicate with the user device to determine a current state of features (i.e., a feature state) on the user device. For example, a server, (e.g., a software feature monitoring and notification server) can analyze a current state of features on the user device to determine whether features currently exist on the user device and/or what version of the feature exist on the user device. At block 520, the computer-implemented can determine whether the user device is lacking previously generated features or feature updates that are needed when by the newly generated features or feature updates to the user device. For example, a user of the user device may not have downloaded previous feature updates to the user device that are needed for the successful incorporation of the newly generated feature update.

If the server has determined that previously generated features or feature updates are needed to add the newly generated features or feature updates to the user device, the computer-implemented method proceeds to block 525 where any previously generated features or feature updates needed for the incorporation of the newly generated features or feature updates on the user device which do not reside on the user device, as well as any documentation associated with the previously generated features or feature updates are assembled, and the computer-implemented method proceeds to block 530. If the server has determined that previously generated features or feature updates are not needed to add the newly generated features or feature updates to the user device, the computer-implemented method proceeds to block 530.

At block 530, the server can accumulate the newly generated features or feature updates and associated documentation, as well as any previously generated features or feature updates and associated documentation. The server can additionally generate and provide a notification to the user device indicating that newly generated features or feature updates exist that could be of interest to the user, as well as provide documentation related to the newly generated features or feature updates. Accordingly, the user can review the documentation to decide whether the newly generated features or feature updates would be beneficial to the user and the operation of the user device.

At block 535, the computer-implemented can determine whether a request to download the newly generated features or feature updates, as well as any previously generated features or feature updates (features) has been received from the user. If a request to download the features has not been made by the user, the computer-implemented method returns to block 505.

If a request to download the features has been made by the user, the computer-implemented method proceeds to block 540 where a server, (e.g., an integrated development environment server 410) can transmit the requested features to the user device. At block 545, the downloaded feature can be incorporated by the user device. For example, a script can be downloaded with the features that can be run in order to incorporate the features in the user device.

Accordingly, a system, a method, and/or computer program product disclosed herein can allow a system programmer on a mainframe platform (e.g., a z/OS platform) environment to enable a new feature of product, created using a continuous delivery (CD) software approach, to be delivered to a computing device within the mainframe platform or outside of the mainframe platform (e.g., email or text message). The delivery can be conducted without destabilizing the mainframe platform environment. In addition, a new feature notification and information associated with the new feature can be provided to the programmer indicating how to activate the new feature, the implications of adding and using the new feature in the mainframe platform environment, and how to leverage capabilities associated with the new feature. Accordingly, the notification and information can be used by the programmer to decide whether to enable or not enable functionality associated with the new feature.

Advantages over previous solutions include: (1) automatic notifications of new features and/or functions availability in a CD model, (2) promptly presenting customers with a description of the new functionality, intent of use the new functionality, advantages of using the new functionality and how to activate the new functionality, (3) significantly lessening an amount of time needed to deploy and/or implement a new function in a production environment, (4) improving adoption of the new feature by users, and (5) immediate direct notification of a new function availability with easy access to information, best practices, and implementation guidelines.

The present invention may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for determining and providing a feature notification within a mainframe environment, the method comprising:
generating, using a processor within the mainframe environment, one or more new features or feature updates;
assembling, using the processor within the mainframe environment, documentation associated with the one or more new features or feature updates;
transmitting, using the processor within the mainframe environment, the assembled documentation to one or more user devices; and
transmitting, using the processor within the mainframe environment, the one or more new features or feature updates to the one or more user devices in response to receiving a request to download the one or more new features or features updates to the one or more user devices.

2. The computer-implemented method of claim 1, further comprising:
determining that the one or more user devices fails to have one or more previously generated features or features updates needed to use the one or more new features or feature updates;
assembling documentation associated with the one or more previously generated features or feature updates; and
transmitting the one or more previously generated features or feature updates to the one or more user devices in response to receiving a request to download the one or more new features or features updates to the one or more user devices.

3. The computer-implemented method of claim 1 further comprising transmitting the feature notification to the one or more user devices regarding the generation of the one or more new features or feature updates.

4. The computer-implemented method of claim 3, wherein the feature notification is transmitted based on a user preferred notification type.

5. The computer-implemented method of claim 1 further comprising incorporating the one or more new features or feature updates into the one or more user devices.

6. The computer-implemented method of claim 1, wherein the documentation includes at least one of: a description of the one or more new features or feature updates, pointers to solution kits associated with the one or more new features or feature updates, video or other documentation on how to use the one or more new features or feature updates, installation information and/or files/scripts to install the one or more new features or feature updates, and who to contact for more information about the one or more new features or feature updates.

7. The computer-implemented method of claim 1, wherein the one or more new features or feature updates are generated according to a continuous delivery model.

8. A computer program product, the computer program product comprising a computer readable storage medium having program instructions embodied therewith, the program instructions readable by a processing circuit to cause the processing circuit to:
generate one or more new features or feature updates;
assemble documentation associated with the one or more new features or feature updates;
transmit the assembled documentation to one or more user devices; and
transmit the one or more new features or feature updates to the one or more user devices in response to receiving a request to download the one or more new features or features updates to the one or more user devices.

9. The computer program product of claim 8, further comprising:
determining that the one or more user devices fails to have one or more previously generated features or features updates needed to use the one or more new features or feature updates;
assembling documentation associated with the one or more previously generated features or feature updates; and
transmitting the one or more previously generated features or feature updates to the one or more user devices in response to receiving a request to download the one or more new features or features updates to the one or more user devices.

10. The computer program product of claim 8 further comprising transmitting the feature notification to the one or more user devices regarding the generation of the one or more new features or feature updates.

11. The computer program product of claim 10, wherein the feature notification is transmitted based on a user preferred notification type.

12. The computer program product of claim 10 further comprising incorporating the one or more new features or feature updates into the one or more user devices.

13. The computer program product of claim 8, wherein the documentation includes at least one of: a description of the one or more new features or feature updates, pointers to solution kits associated with the one or more new features or feature updates, video or other documentation on how to use the one or more new features or feature updates, installation information and/or files/scripts to install the one or more new features or feature updates, and who to contact for more information about the one or more new features or feature updates.

14. The computer program product of claim 8, wherein the one or more new features or feature updates are generated according to a continuous delivery model.

15. A computer system, comprising:
a processor in communication with one or more types of memory, the processor configured to:
generate one or more new features or feature updates;
assemble documentation associated with the one or more new features or feature updates;
transmit the assembled documentation to one or more user devices; and
transmit the one or more new features or feature updates to the one or more user devices in response to receiving a request to download the one or more new features or features updates to the one or more user devices.

16. The computer system of claim 15, wherein the processor is further operable to:
determine that the one or more user devices fails to have one or more previously generated features or features updates needed to use the one or more new features or feature updates;
assemble documentation associated with the one or more previously generated features or feature updates; and
transmit the one or more previously generated features or feature updates to the one or more user devices in response to receiving a request to download the one or more new features or features updates to the one or more user devices.

17. The computer system of claim 15, wherein the processor is further operable to transmit the feature notification to the one or more user devices regarding the generation of the one or more new features or feature updates.

18. The computer system of claim 17, wherein the feature notification is transmitted based on a user preferred notification type.

19. The computer system of claim 15, wherein a processor of the one or more user devices is operable to incorporate the one or more new features or feature updates into the one or more user devices.

20. The computer system of claim 15, wherein the documentation includes at least one of: a description of the one or more new features or feature updates, pointers to solution kits associated with the one or more new features or feature updates, video or other documentation on how to use the one or more new features or feature updates, installation information and/or files/scripts to install the one or more new features or feature updates, and who to contact for more information about the one or more new features or feature updates.
